(19) United States
(12) Patent Application Publication
(10) Pub. No.: US 2014/0324503 A1
(43) Pub. Date: Oct. 30, 2014

(54) MULTI-SOURCE DATA SUBSCRIPTIONS

(71) Applicant: MICROSOFT CORPORATION, Redmond, WA (US)

(72) Inventors: Bruce Kevin Whittaker, Los Gatos, CA (US); Brian C. Beckman, Newcastle, WA (US)

(73) Assignee: Microsoft Corporation, Redmond, WA (US)

(21) Appl. No.: 13/873,779

(22) Filed: Apr. 30, 2013

(51) Int. Cl. G06Q 10/10; G06F 17/28

(52) U.S. Cl. CPC G06Q 10/1095; G06F 17/28
USPC 705/7.19; 704/9

(57) ABSTRACT

Techniques and/or systems are provided for performing an action based upon a subscription to multi-source data. That is, a subscription may specify one or more actions that are to be performed upon satisfaction of a set of conditions associated with one or more data sources. For example, a subscription for a user Joe may specify that a flower order is to be placed when a current date is Valentine's day, a social network profile for Joe indicates Joe has a significant other, and a local flower shop has roses in stock. In this way, a subscription may be based upon various data sources, such as a calendar, a social network, and a flower supply data source. Because a vast number of subscriptions may be maintained, conditions may be organized into a graph such that a condition, shared by multiple subscriptions, is represented by a single node within the graph.

### BACKGROUND

Many computing environments allow users to setup subscriptions to information and/or events. In an example, a calendar application may remind a user when a calendar event is about to occur (e.g., a notification of a meeting). In another example, a mobile device may notify a user when a battery level of the mobile device is below a threshold. In another example, a user may subscribe to a news feed that provides news updates. In this way, a subscription may notify a user when a simple event occurs based upon information from a single data source (e.g., a user calendar, a battery of a mobile device, a news feed, etc.).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for performing an action based upon a subscription to multi-source data are provided herein. A subscription service, such as a cloud-based subscription service, may maintain a plurality of subscriptions to various data sources (e.g., subscriptions may be maintained for billions of social network users to millions of data sources, such as news feeds, bank information, weather information, stock information, computing device information, social network information, etc.). Because a vast number of subscriptions may be maintained and/or data sources may be monitored, subscriptions may be organized and/or consolidated to accommodate such a large scale. It is to be appreciated that monitored, monitoring and/or the like are not meant to imply that the instant application is limited to pulling scenarios. That is, the instant application is intended to cover push scenarios as well. For example, the instant application is intended to cover publication and subscription scenarios where one or more entities publish one or more events, data, etc. and one or more other entities subscribe to at least some of the one or more events, data, etc. Such a publication and subscription scenario may be more of a push model where publications are pushed to subscribers as opposed to subscribers polling for or pulling publication data. Thus, monitored, monitoring and/or the like are intended to cover situations where data is emitted or pushed from a source to a subscribing entity. That is, monitored, monitoring and/or the like are not limited to a subscribing entity reaching out (e.g., periodically) for data, but instead cover situations where data is pushed to a subscribing entity, where a subscribing entity listens to a data source for data from that data source, etc., for example.

In an example, a subscription may comprise a set of conditions associated with one or more data sources (e.g., a first subscription may specify that a user is to be notified when a first condition, such as the start of a new football season, and a second condition, such as a Blue football team not trading Jim, are met). Because multiple subscriptions may specify the first condition (e.g., thousands of users may be interested in when the new football seasons starts), the first condition may be shared amongst such subscriptions (e.g., merely a single instance of the first condition may be maintained as opposed to redundant instances of the first condition), which may mitigate redundant storage and/or other duplicative efforts to facilitate scaling. For example, a graph may comprise a plurality of nodes representing conditions. Because the graph may represent a condition using merely a single node (e.g., a first node may represent the first condition, such that multiple subscriptions, specifying the first condition, may be associated with the first node), the graph may be efficiently traversed (e.g., the graph may be relatively “compressed”, for example, because the first condition is represented by a single node as opposed to thousands of nodes corresponding to the thousands of subscriptions specifying the first condition) to determine whether a set of conditions associated with a subscription are met, thus triggering an action. In some embodiments, a shared condition (e.g., battery level less than 20%) may be parameterized for particular users (e.g., the shared condition may be based upon a parameter indicative of a particular user device). It is to be appreciated that although a graph is described herein, the instant application, including the scope of the appended claims, is not intended to be so limited. For example, other structures such as a tree structure, a database, a table, an object, etc. may be used as well.

In an example of generating a subscription, a subscription request may be received by a subscription service (e.g., a cloud-based subscription service). The subscription request may specify an action that is to be performed upon satisfaction of a set of conditions. For example, a user may specify an expression “I want to receive an email when the new football season starts so long as the Blue football team did not trade Jim” according to a first language syntax (e.g., plain English, a programming language, a query language, an expressive language, etc.), which may be normalized to an intermediary expressive language syntax to generate a converted expression. The expression may be normalized because various users may specify similar concepts using different language (e.g., “notify me by email of the new football season, but please don't if the Blue team traded Jim”). The converted expression may be decomposed into one or more subexpressions, such as a first subexpression (a first condition: “current date=start of football season”), a second subexpression (a second condition: “Blue team roster=Jim”), a third subexpression (action: “send email regarding new football season”), etc. In this way, a set of conditions may be identified from the subscription request. In some embodiments, the set of conditions may comprise a first condition associated with a first data source (e.g., a current date may be derived from a calendar data source associated with the user), a second condition associated with a second data source (e.g., a roster from a Blue team website), and/or other conditions associated with other data sources.

A subscription may be generated based upon the subscription request. For example, the first condition (“current date=start of football season”), may already be monitored as a current node within a graph by the subscription service because other subscriptions may specify the first condition. Thus, the subscription may reference the current node within the graph for the first condition, as opposed to creating a redundant node within the graph. However, the second condition (“Blue team roster=Jim”) may be a new condition, and thus a new node for the second condition may be created within the graph. In this way, the subscription may be generated based upon the set of conditions. The first data source may be monitored for a first event that triggers the first condition (e.g., the first condition may be triggered based upon the calendar data source indicating (e.g., pushing) the current date as the start of the football season). The second data source may be monitored for a second event that triggers the second condition (e.g., the second condition may be triggered based upon the Blue team website providing (e.g., pushing) a current roster that comprises Jim). Responsive to an identification that the first event satisfies the first condition and the second event satisfies the second condition, the action may be performed (e.g., an email notification may be sent to the user). It may be appreciated that a subscription may be based upon any number of conditions that may be related or unrelated (e.g., a date, a football team trading a player, a stock price, a relationship status of a social network, etc.), and that such conditions may rely upon various independent data sources (e.g., a user calendar, a mobile device location, a football team schedule, a social network, etc.). In some embodiments, a subscription may comprise more than one condition that is associated with a single data source (e.g., “notify user when stock price goes below 25 or above 35”, where a first condition “stock price <25” and a second condition “stock price >35” are listened for from a stock market data source). That is, a single data source can be monitored/listened to for multiple conditions, where a first condition of the multiple conditions and a second condition of the multiple conditions may be for the same and/or different subscriptions, for example. It may be appreciated that events may trigger in any order with any amount of time between event triggers. The subscription service may scale to accommodate a vast amount of subscriptions to various data sources by sharing conditions (e.g., a single node represents a condition that may be specified by thousands of subscriptions) and/or organizing conditions into a data structure (e.g., a graph may represent conditions, such that the graph may be traversed to identify triggering conditions and/or may be traversed to update conditional information based upon update information received from data sources).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of performing an action based upon a subscription to multi-source data.

FIG. 2 is a component block diagram illustrating an exemplary system of generating a subscription to multi-source data.

FIG. 3 is a component block diagram illustrating an exemplary system for maintaining one or more subscriptions to multi-source data.

FIG. 4 is a component block diagram illustrating an exemplary system for generating a subscription to multi-source data.

FIG. 5 is a component block diagram illustrating an exemplary system for maintaining one or more subscriptions to multi-source data.

FIG. 6 is a component block diagram illustrating an exemplary system for performing an action based upon a subscription to multi-source data.

FIG. 7 is an illustration of an example of one or more subscriptions maintained by a subscription component.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

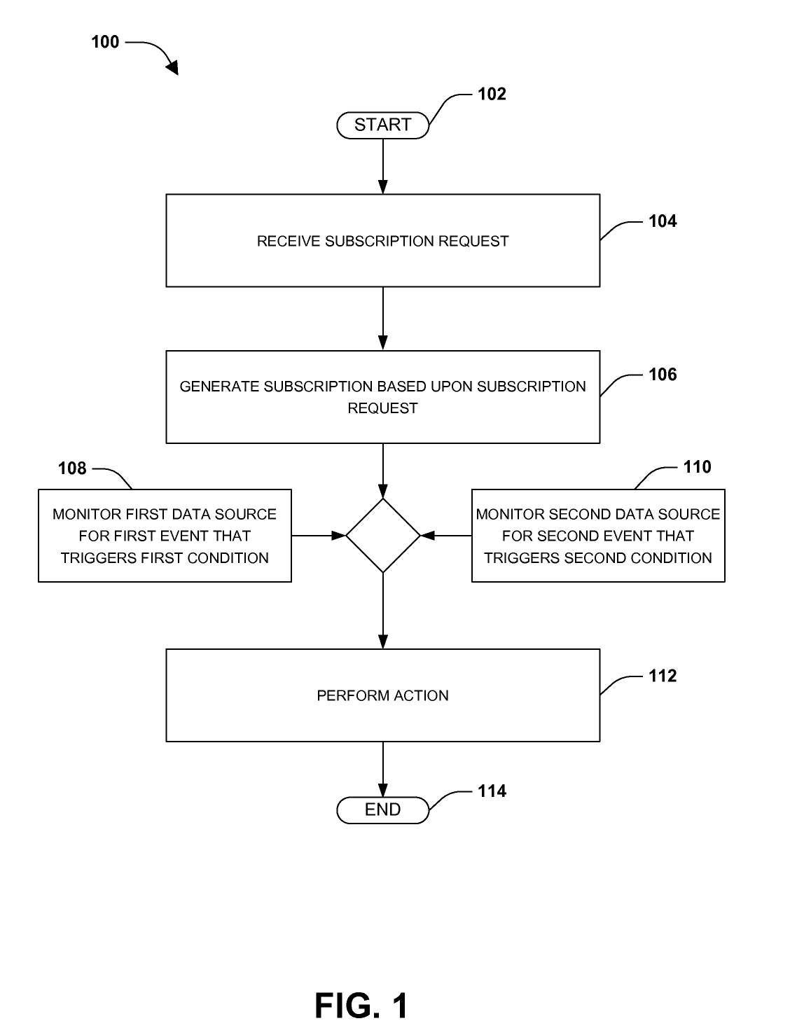

An embodiment of performing an action based upon a subscription to multi-source data is illustrated by an exemplary method 100 of FIG. 1. At 102, the method starts. At 104, a subscription request is received. For example, a cloud based subscription service may receive the subscription request from a client, such as a mobile device, a laptop, a tablet, a car navigational unit, an embedded system, etc. The subscription request may specify an action that is to be performed upon satisfaction of a set of conditions. In one example, the set of conditions may comprise a first condition associated with a first data source, a second condition associated with a second data source, and/or other conditions associated with other data sources (e.g., a sports team website data source, a stock ticker data source, a news feed data source, a device battery status data source, a fire alarm sensor data source, a car gas sensor data source, a calendar data source, an email account data source, a social network data source, a photo sharing website data source, a consume good marketplace website data source, and/or any other source of information). For example, the first data source may correspond to a first data feed, and the second data source may correspond to a second data feed that is different than and/or unrelated to the first data feed (e.g., a football team website, a user calendar, etc.).

In some embodiments, the subscription request comprises an expression indicative of the action and/or the set of conditions (e.g., a plain language statement, a query, a programming language statement, an expressive language statement, etc.). The expression may be decomposed into the set of conditions or subexpressions. For example, the expression (e.g., “send me an email when the new football schedule comes out so long as the Blue team didn't trade Tim”) may be decomposed into a first subexpression (“when the new football schedule comes out”). The first subexpression (“when the new football schedule comes out”) may be normalized and/or used to derive a first condition (“current date=start of football season”). The expression may be decomposed into a second subexpression (“so long as the Blue team didn't trade Tim”), which may be normalized and/or used to derive a second condition (“Blue team roster=Tim”). The expression may be decomposed into a third subexpression (“send me an email when”), which may be normalized and/or used to derive the action (“action=send email to subscriber”) and/or into more or fewer subexpressions/conditions.

In some embodiments, the set of conditions is represented by an expression that is formatted according to a first language syntax (e.g., an expression written in an object oriented programming language). The expression may be converted from the first language syntax to an intermediary expressive language syntax to generate a normalized expression. The intermediary expressive language syntax may allow the normalized expression to be converted to another syntax. For example, the normalized expression may be converted from the intermediary expressive language syntax to a second language syntax (e.g., an expressive language, a query language, etc.) to generate a converted expression, which may be evaluated to identify a set of conditions and/or data sources (e.g., a Blue team website that provides a Blue team roster) associated with the subscription request.

At 106, a subscription may be generated based upon the subscription request. Because a large number of subscriptions, accessing a plethora of data sources, may be maintained for a large number of users (e.g., billions of subscriptions that access millions of data sources may be maintained), a graph (e.g., and/or other structure(s)) may be maintained for tracking subscriptions and/or for processing information events received from data sources (e.g., a current roster received by a Blue team website). The graph may comprise a plurality of nodes. A node may represent a condition associated with one or more subscriptions (e.g., a condition associated with a single subscription or a condition shared amongst multiple subscriptions). In an example, a current node within the graph may be identified based upon the current node representing the first condition (“current date=start of football season”) associated with the subscription request. The graph may already comprise the current node because one or more users may have previously created subscriptions that specify the first condition (e.g., a subscription where a second user wants to purchase season tickets at the start of the football season so long as the user has expressed an interest in football through a social network profile). Accordingly, the subscription may be associated with the current node. In another example, the graph may not comprise a node representing the second condition (“Blue team roster=Tim”), and thus a second node (e.g., a new node) may be generated within the graph to represent the second condition. The subscription may be associated with the second node. In some embodiments, one or more nodes associated with the subscription may be ordered based upon restrictiveness of conditions. For example, the second node may be ordered before the first node because the probability that the Blue team may trade Tim is relatively high, and thus the first condition is relatively less restrictive than the second condition. In some embodiments, the subscription is constructed based upon a first subexpression corresponding to the first node (e.g., representing a condition shared by many subscriptions) and a second subexpression corresponding to the second node (e.g., representing a non-shared condition).

At 108, the first data source may be monitored (e.g., listened to) for a first event that triggers the first condition. That is, when a data source pushes a new event such as an information event, content of the new event may be evaluated and/or used to dispatch the event to a corresponding node and/or nodes within the graph. For example, information events from a calendar data source (e.g., a football calendar data feed) may be received and/or used to update the first node and/or other nodes within the graph (e.g., responsive to an information event indicating that a football pre-season has started, one or more nodes representing conditions associated with the football pre-season may be updated). At 110, the second data source may be monitored (e.g., listened to) for a second event that triggers the second condition. For example, information events from a Blue team website may be received and/or used to update the second node and/or other nodes within the graph (e.g., responsive to an information event indicating that the Blue team traded Tim, one or more nodes representing conditions associated with the Blue team and/or Tim may be updated).

At 112, responsive to identifying the first event as satisfying the first condition and the second event as satisfying the second condition, the action may be performed. It may be appreciated that conditions may be satisfied in any order with any amount of time between triggering events (e.g., the first condition may be satisfied before the second condition; the second condition may be satisfied before the first condition; etc.). In some embodiments, when an information event is received from a data source (e.g., the Blue team website may provide information regarding a current roster), the graph may be traversed to determine whether one or more conditions are satisfied by the information event.

The action may correspond to any type of action that may be performed, such as a purchase item action (e.g., purchase a video game based upon satisfaction of one or more conditions, such as a price dropping below a price threshold and there being free shipping, etc.), a notification action to a subscription owner, a secondary notification action to a non-subscription owner, a download action (e.g., download an application based upon satisfaction of one or more conditions, such as a device comprising a particular amount of available storage space), an update social network action (e.g., creation of a social network post based upon satisfaction of one or more conditions, such as a birthday condition), and/or a wide variety of other actions. In some embodiments, multiple actions may be performed, such as sending a company newsletter to a user and purchasing 10 shares of stock. In some embodiments, a subscription and/or other subscriptions may be maintained after performance of the action (e.g., a subscription “notify me whenever my home team scores” may be maintained until an end of a game, as opposed to ending after the home team scores the first time; a subscription “remind me of my anniversary” may be maintained indefinitely; etc.). At 114, the method ends.

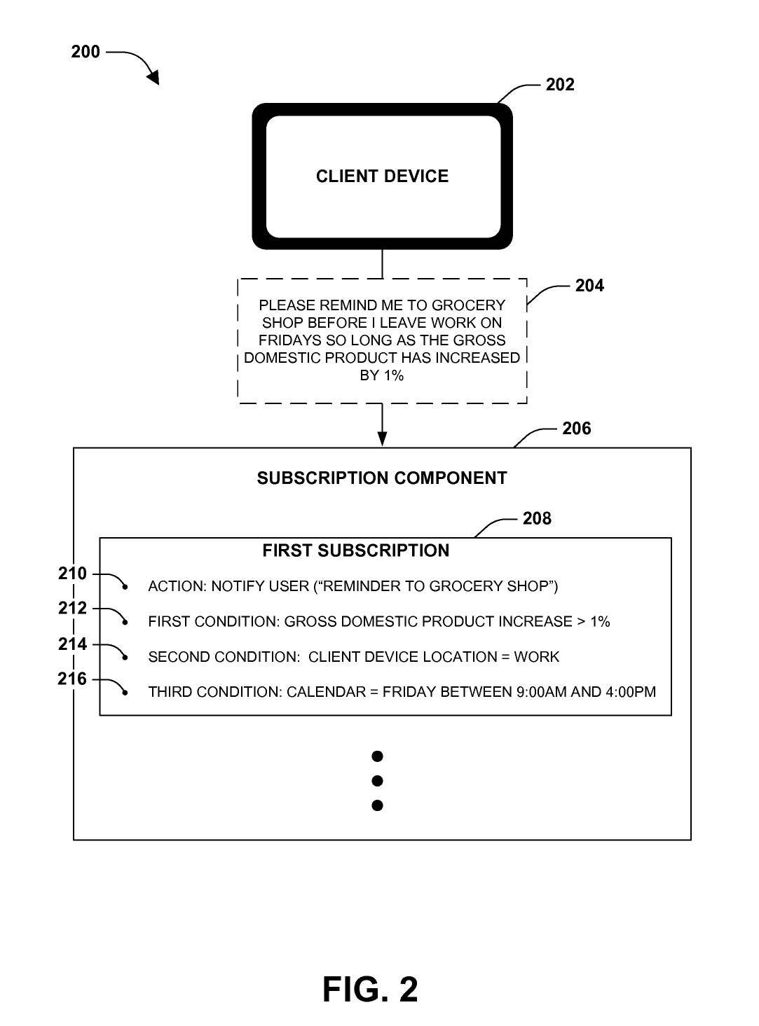

FIG. 2 illustrates an example of a system 200 for generating a subscription to multi-source data. The system 200 may comprise a subscription component 206. The subscription component 206 may be configured to receive a subscription request 204 from a client device 202, such as a tablet device. In an example, a user A may create an expression “please remind me to grocery shop before I leave work on Fridays so long as the gross domestic product has increased by 1%. Because the expression may correspond to one or more concepts that may be expressed in various manners (e.g., “so long as the GDP has increased by one percent or more”, “if GDP has gained more than 1%”, “when the gross domestic product has seen an increase better than one percent”, etc. may all represent the same concept), the subscription component 206 may normalize the expression to create a normalized expression, which may be evaluated and/or compared with other normalized expressions in order to identify similar concepts.

The subscription component 206 may decompose the normalized query into one or more subexpressions that may be used to derive an action 210 and/or a set of conditions that trigger performance of the action 210. For example, the action 210 may correspond to a user notification action that is based upon a subexpression “reminder to grocery shop”. A first condition 212 may correspond to a subexpression “gross domestic product increase >1%”, which may be associated with an economic statistics data source. A second condition 214 may correspond to a subexpression “client device location=work”, which may be associated with a device location data source parameterized by client device 202. A third condition “calendar=Friday between 9:00 am and 4:00 pm”, which may be associated with a calendar data source. In this way, the subscription component 206 may generate a first subscription 208 based upon the action 210, the first condition 212, the second condition 214, and/or the third condition 216, for example.

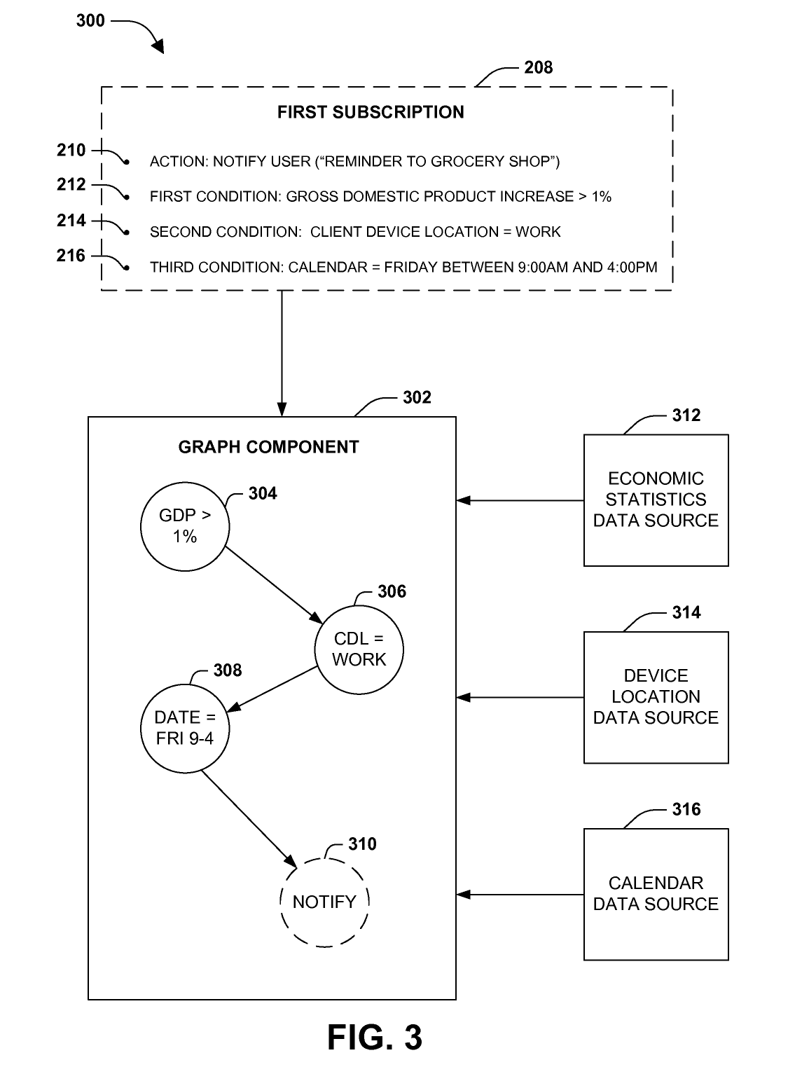

FIG. 3 illustrates an example of a system 300 configured for maintaining one or more subscriptions to multi-source data. In one example, a first subscription 208 may correspond to the first subscription 208 generated by the subscription component 206, as illustrated in FIG. 2. The system 300 may comprise a graph component 302. Because a subscription service may maintain a large number of subscriptions comprising conditions that are based upon information provided by a wide variety of data sources (e.g., billions of subscriptions associated with millions of data sources), the graph component 302 may maintain a graph comprising a plurality of nodes, where a node represents a condition specified by one or more subscriptions. It may be appreciated that FIG. 3 may illustrate merely a portion of the graph for simplicity, and that the graph may correspond to a plethora of conditions associated with any number of subscriptions (e.g., millions conditions associated with billions of subscriptions). Because multiple subscriptions may share a similar condition (e.g., a condition “new football schedule released=true” may be shared by multiple subscriptions of various users, such as subscriptions dealing with buying tickets, receiving an email with a season schedule, trading a player through a fantasy football league, etc.), a node, representing a condition, may be shared by multiple subscriptions specifying the condition. In this way, the graph may be maintained and/or traversed in order to efficiently manage incoming information events from data sources and/or to determine whether a set of conditions of a subscription are satisfied, thus triggering performance of an action. It may be appreciated that other data structures (e.g., a tree structure, a database table, an object, a publication/subscription model, etc.) or no data structure may be used to manage conditions. That is, the instant application, including the scope of the appended claims, is not limited to a graph, as illustrated in FIG. 3, for example.

In an example, the first condition 212 may be represented by a first node 304 within the graph, and may be associated with an economic statistics data source 312. The second condition 214 may be represented by a second node 306 within the graph, and may be associated with a device location data source 314 that may be parameterized based upon the client device 202 of user (A). The third condition 216 may be represented by a third node 308 within the graph, and may be associated with a calendar data source 316. In some embodiments, the first node 304, the second node 306, and/or the third node 308 may be shared between the first subscription 208 and one or more other subscriptions (e.g., other subscriptions may have the first condition 212 of “gross domestic product increase >1%”). In some embodiments, the first node 304, the second node 306, and/or the third node 308 may be associated with merely the first subscription 208. In an example, the first node 304 may be ordered before the second node 306 because the first condition 212 may be relatively more restrictive than the second condition 214. Thus, the graph may be efficiently traversed when determining whether the action 210, represented by a first action node 310, is to be performed (e.g., if the first condition 212, which may be relatively harder to satisfy, is not satisfied, then the traversal may be efficiently halted before advancing to other nodes.

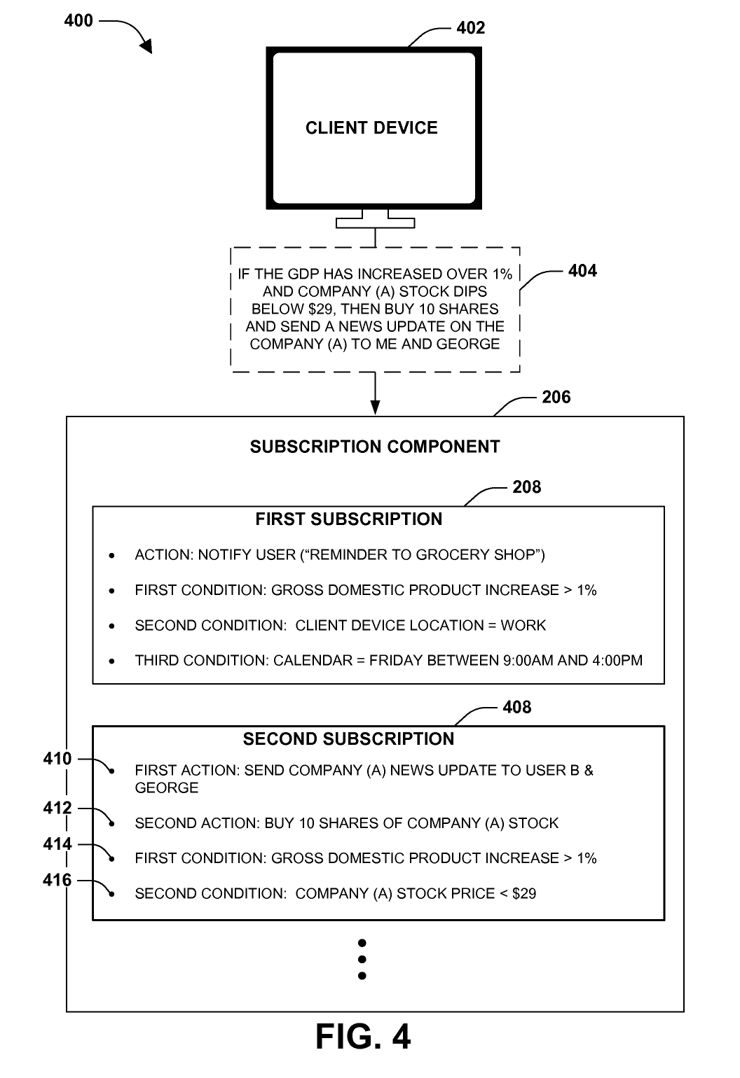

FIG. 4 illustrates an example of a system 400 for generating a subscription to multi-source data. The system 400 may comprise a subscription component 206. In an example, the subscription component 206 corresponds to the subscription component 206 illustrated in FIG. 2. For example, the subscription component 206 may maintain a first subscription 208 associated with a client device 202 of user A. The subscription component 206 may be configured to generated and/or maintain other subscriptions associated with other users. Nevertheless, a non-linear (e.g., parallel) progression through nodes is contemplated as well. That is, the instant application, including the scope of the appended claims, is not limited to a serial progression through nodes, as illustrated in FIG. 3, for example.

In an example, as illustrated in FIG. 4, the subscription component 206 may receive a subscription request 404 from a client device 402, such as a desktop device. In an example, a user B may create an expression “if the GDP has increased over 1% and company (A) stock dips below $29, then buy 10 shares and send a news update on the company (A) to me and George”. Because the expression may correspond to one or more concepts that may be expressed in various manners, the subscription component 206 may normalize the expression to create a normalized expression, which may be evaluated and/or compared with other normalized expressions in order to identify similar concepts.

The subscription component 206 may decompose the normalized query into one or more subexpressions that may be used to derive a first action 410, a second action 412, and/or a set of conditions that trigger performance of the first action 410 and/or the second action 412. For example, the first action 410 may correspond to a user notification action to the user B and a secondary notification to George based upon a subexpression “send company (A) news update to user B and George”. The second action 412 may correspond to a purchase action based upon a subexpression “buy 10 shares of company (A) stock”. A first condition 414 may correspond to a subexpression “gross domestic product increase >1%”, which may be associated with an economic statistics data source. A fourth condition 416 may correspond to a subexpression “company (A) stock price <$29”, which may be associated with a stock data source. In this way, the subscription component 206 may generate a second subscription 408 based upon the first action 410, the second action 412, the first condition 414 (e.g., which is also in the first subscription 208), and/or the fourth condition 416.

In an example, a subscription may have a recursive nature (e.g., be based on other subscriptions). For example, a third subscription may correspond to condition A, condition B, and condition C. A fourth subscription may correspond to condition Q, condition R, and condition S. A fifth subscription may listen to the third subscription and the fourth subscription. In this way, the fifth subscription may be recursive in nature with respect to the third subscription and the fourth subscription.

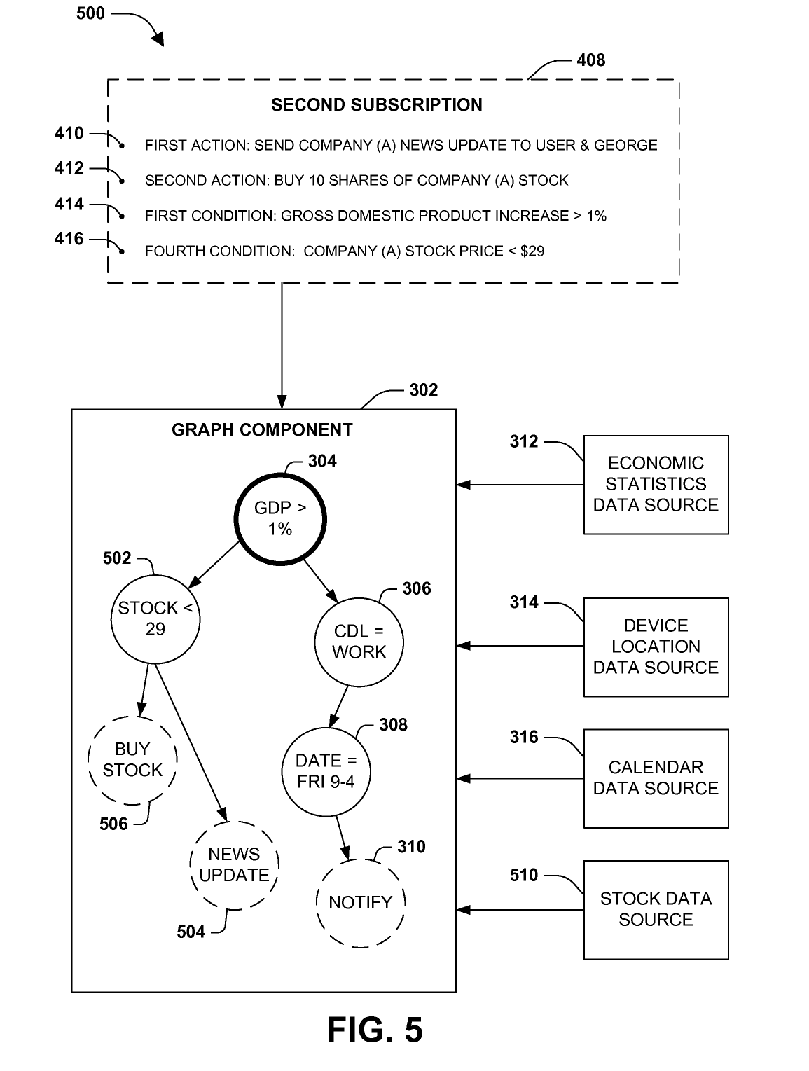

FIG. 5 illustrates an example of a system 500 configured for maintaining one or more subscriptions to multi-source data. In one example, a second subscription 408 may correspond to the second subscription 408 generated by the subscription component 206, as illustrated in FIG. 4. The system 500 may comprise a graph component 302. The graph component 302 may maintain a graph corresponding to one or more subscriptions. For example, the graph may comprise a plurality of nodes, where a node represents a condition specified by one or more subscriptions. It may be appreciated that FIG. 5 may illustrate merely a portion of the graph for simplicity (e.g., the graph may comprise one or more nodes, such as a first node 304, a second node 306, a third node 308, and/or a first action node 310, corresponding to actions and/or conditions of a first subscription 208, as illustrated in FIG. 3), and that the graph may correspond to a plethora of conditions associated with any number of subscriptions.

In an example, a first condition 414 may be represented by the first node 304. Because the first node 304 is already associated by the first subscription 208 (e.g., based upon the first subscription specifying the first condition 212), the first node 304 may be shared by the first subscription 208 and the second subscription 408 for efficient storage, updating, and/or traversal of conditions represented by nodes of the graph (e.g., as opposed to storing a redundant node for the first condition 414). The first node 304 may be associated with an economic statistics data source 312. The fourth condition 416 may be represented by a fourth node 502 within the graph, and may be associated with a stock data source 510. The first action 410 may be represented by a second action node 504 within the graph, and the second action 412 may be represented by a third action node 506 within the graph. In this way, the graph may be traversed to determine whether actions associated with one or more subscriptions are to be performed based upon satisfaction of conditions (e.g., as indicated by information events received from various data sources).

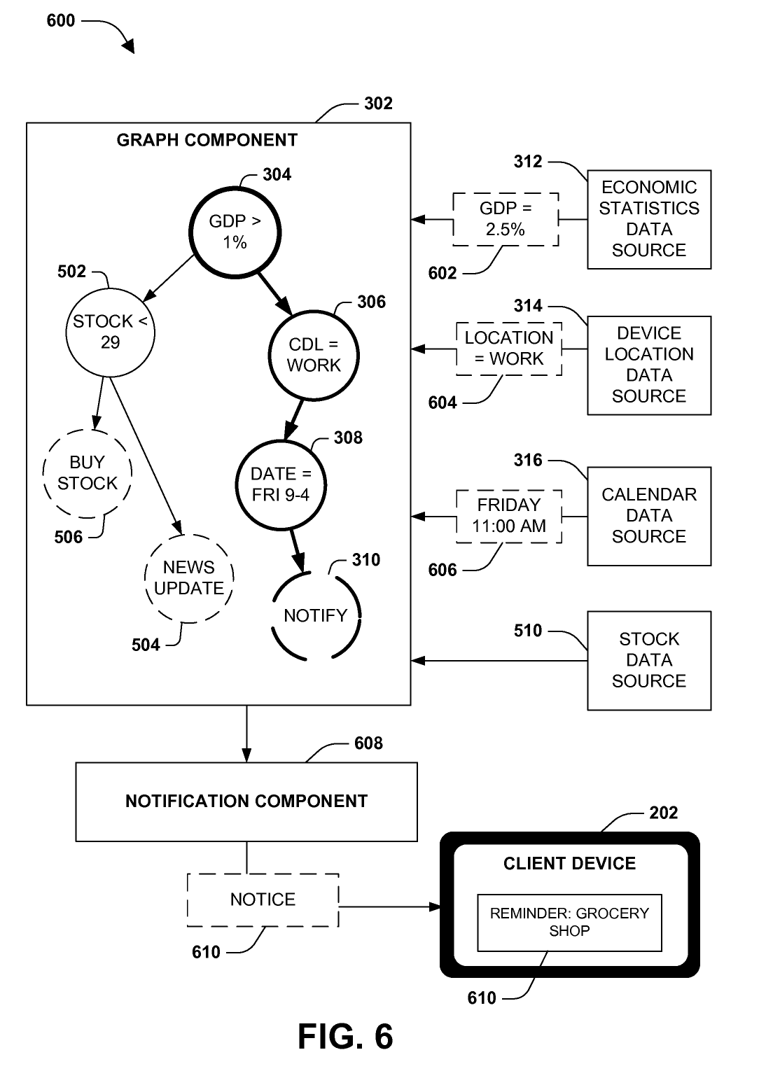

FIG. 6 illustrates an example of a system 600 for performing an action based upon a subscription to multi-source data. The system 600 may comprise a graph component 302 configured to maintain a graph associated with one or more subscriptions. For example, a first node 304 may represent a condition “gross domestic product increase >1%” shared by a first subscription 208 and a second subscription 408, which may be updated based upon information events provided by an economic statistics data source 312. A second node 306 may represent a condition “client device location=work” associated with the first subscription 208, which may be updated based upon information events provided by a device location data source 314. A third node 308 may represent a condition “calendar=Friday between 9:00 am and 4:00 pm” associated with the first subscription 208, which may be updated based upon information events provided by a calendar data source 316. A fourth node 502 may represent a condition “company (A) stock price <$29” associated with the second subscription 408, which may be updated based upon information events provided by a stock data source 510. It may be appreciated that FIG. 6 may illustrate merely a portion of the graph for simplicity. The graph component 302 may be configured to update one or more nodes within the graph based upon information events provided by data sources. For example, the first node 304, with respect to the first subscription 208, may be updated with a value of “GDP=2.5%” or “true” based upon an information event 602 (e.g., a first triggering event) received from the economic statistics data source 312. The second node 306 may be updated with a value of “work” based upon an information event 604 (e.g., a second triggering event) received from the device location data source 604 (e.g., the client device 202 may indicate that the client device 202 is located at the user's work). The third node 308 may be updated with a value of “Friday 11:00 AM” based upon an information event 606 (e.g., a third triggering event) received from the calendar data source 316 (e.g., a user calendar on the client device 202 may indicate a current date and time as Friday 11:00 AM).

The system 600 may comprise a notification component 608. The notification component 608 may be configured to determine (e.g., be made aware of) whether a set of conditions associated with a subscription is satisfied. In some embodiments, the action is performed responsive to the set of conditions being satisfied based upon a current state of the graph (e.g., as opposed to a tracking/storage scheme of intermediate and/or historic values of various conditions, for example). In an example of monitoring a first set of conditions associated with the first subscription 208, the notification component 608 may determine that the first node 304 indicates that the condition “gross domestic product increase >1%” is satisfied based upon the information event 602. The notification component 608 may determine that the second node 306 indicates that the condition “client device location=work” is satisfied based upon the information event 604. The notification component 608 may determine that the third node 308 indicates that the condition “calendar=Friday between 9:00 am and 4:00 pm” is satisfied based upon the information event 606. Because the first set of conditions associated with the first subscription 208 is satisfied, the notification component may perform the first action 310 by sending a notice 610 to the client device 202, such as a reminder to grocery shop.

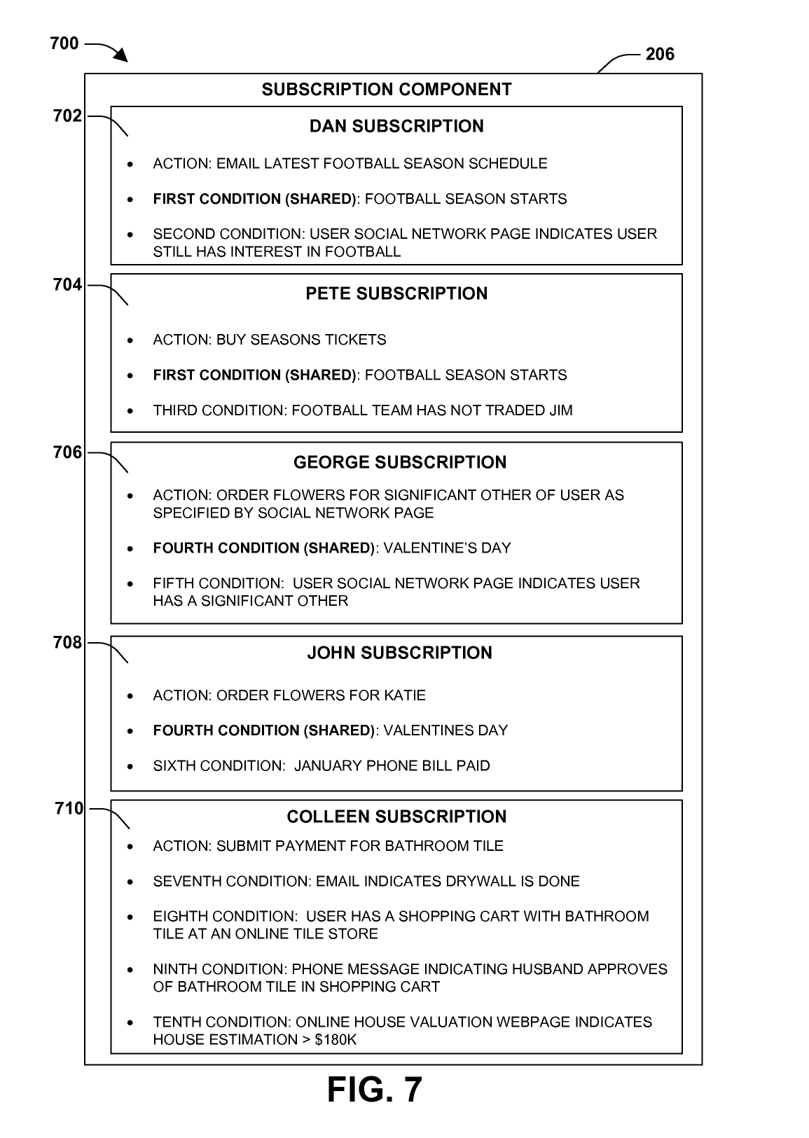

FIG. 7 illustrates an example 700 of one or more subscriptions maintained by a subscription component 206. In an example, a Dan subscription 702 may be maintained for user Dan. The Dan subscription 702 may comprise a first condition “football season starts” associated with a football league website data source and a second condition “user social network page indicates user still has interest in football” associated with a social network data source. Responsive to satisfaction of the first condition (e.g., represented by a first node within a graph) and the second condition (e.g., represented by a second node within the graph), an email of the latest football season schedule may be emailed to user Dan. In another example, a Pete subscription 704 may be maintained for user Pete. The Pete subscription 704 may comprise the first condition “football season starts” associated with the football league website data source and a third condition “football team has not traded Jim” associated with a football team roster data source. The first condition “football season starts” may be shared between the Pete subscription 704 and the Dan subscription 702, such that the Pete subscription 704 and the Dan subscription 702 are both associated with the first node representing the first condition. Sharing the first condition and/or other conditions may allow for efficient storage, updating, and/or traversal of the graph because merely non-overlapping nodes, which may not correspond to redundant conditions, may be stored within the graph. Responsive to satisfaction of the first condition (e.g., represented by the first node that is shared with the Dan subscription 702) and the third condition (e.g., represented by a third node within the graph), season tickets may be purchased for user Pete.

In another example, a George subscription 706 may be maintained for user George. The George subscription 706 may comprise a fourth condition “Valentine's day” associated with a calendar data source and a fifth condition “user social network page indicates user has significant other”. Responsive to satisfaction of the fourth condition (e.g., represented by a fourth node within a graph) and the fifth condition (e.g., represented by a fifth node within the graph), a flower order for George's significant other, as specified by George's social network page, may be placed. In another example, a John subscription 708 may be maintained for a user John. The John subscription 708 may comprise the fourth condition “Valentine's day” associated with the calendar data source and a sixth condition “January phone bill paid” associated with a phone company data source. The fourth condition “Valentines' day” may be shared between the George Subscription 706 and the John subscription 708, such that the George Subscription 706 and the John subscription 708 are both associated with the fourth node representing the fourth condition (e.g., as opposed to two separate redundant nodes). Responsive to satisfaction of the fourth condition (e.g., represented by the fourth node that is shared with the George subscription 706) and the sixth condition (e.g., represented by a sixth node within the graph), a flower order for Katie may be placed.

In another example, a Colleen subscription 710 may be maintained for user Colleen. The Colleen subscription 710 may comprise a seventh condition “email indicates drywall is done” associated with an email data source, an eighth condition “user has a shopping cart with bathroom tile at an online tile store” associated with an online tile store data source, a ninth condition “phone message indicating husband approves of bathroom tile in shopping cart” associated with a voicemail data source, and a tenth condition “online house valuation webpage indicates house estimate >$180k” associated with an online house valuation webpage data source. Responsive to satisfaction of the seventh condition (e.g., represented by a seventh node within the graph), the eighth condition (e.g., represented by an eighth node within the graph), the ninth condition (e.g., represented by a ninth node within the graph), and the tenth condition (e.g., represented by a tenth node within the graph), a payment may be submitted for the bathroom tile.

In some embodiments, a subscription request specifying an action that is to be performed based upon information associated with a data source may be received. For example, the subscription request may specify “notify me when the football schedule is published”. A subscription may be generated based upon the subscription request. The data source, such as a football league data source, may be listened to for information regarding the subscription. Responsive to information received from the data source satisfying the subscription (e.g., the subscription may be satisfied once a year when a new football schedule is published), the action may be performed. It may thus be appreciated that in some embodiments a subscription has no conditions (e.g., condition(s) optional). For example, “notify me when the football schedule is published” may simply be satisfied (e.g., such that a corresponding action is performed) once a year when a new football schedule is published.

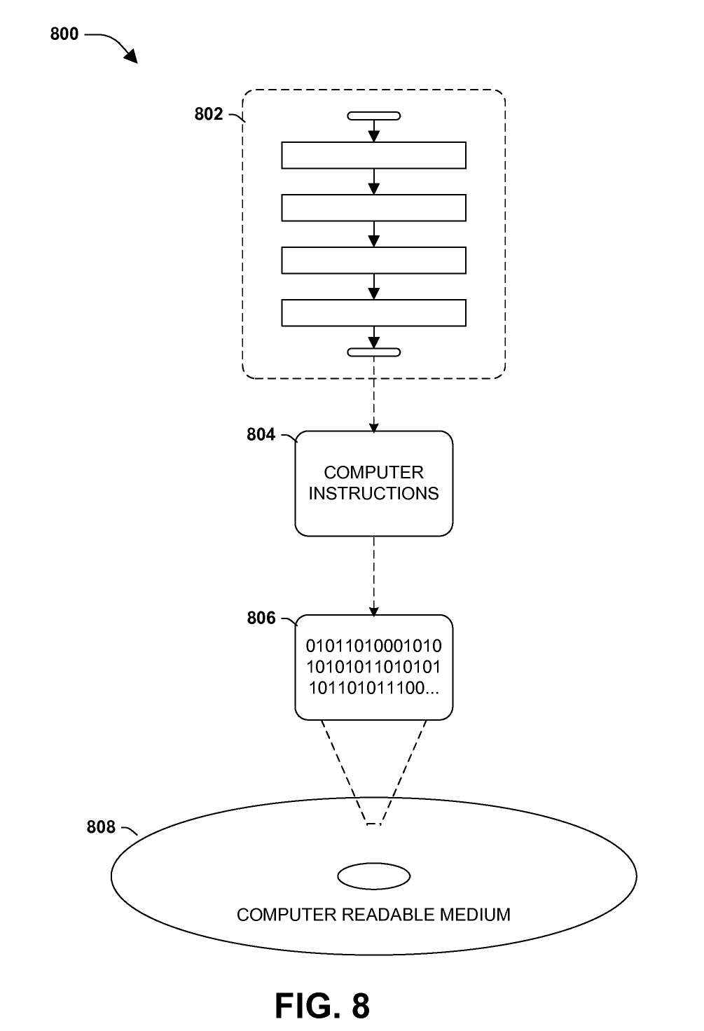

Still another embodiment involves a computer-readable medium comprising processor-executable instructions configured to implement one or more of the techniques presented herein. An example embodiment of a computer-readable medium or a computer-readable device that is devised in these ways is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1, for example. In some embodiments, the processor-executable instructions 804 are configured to implement a system, such as at least some of the exemplary system 200 of FIG. 2, at least some of the exemplary system 300 of FIG. 3, at least some of the exemplary system 400 of FIG. 4, at least some of the exemplary system 500 of FIG. 5, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

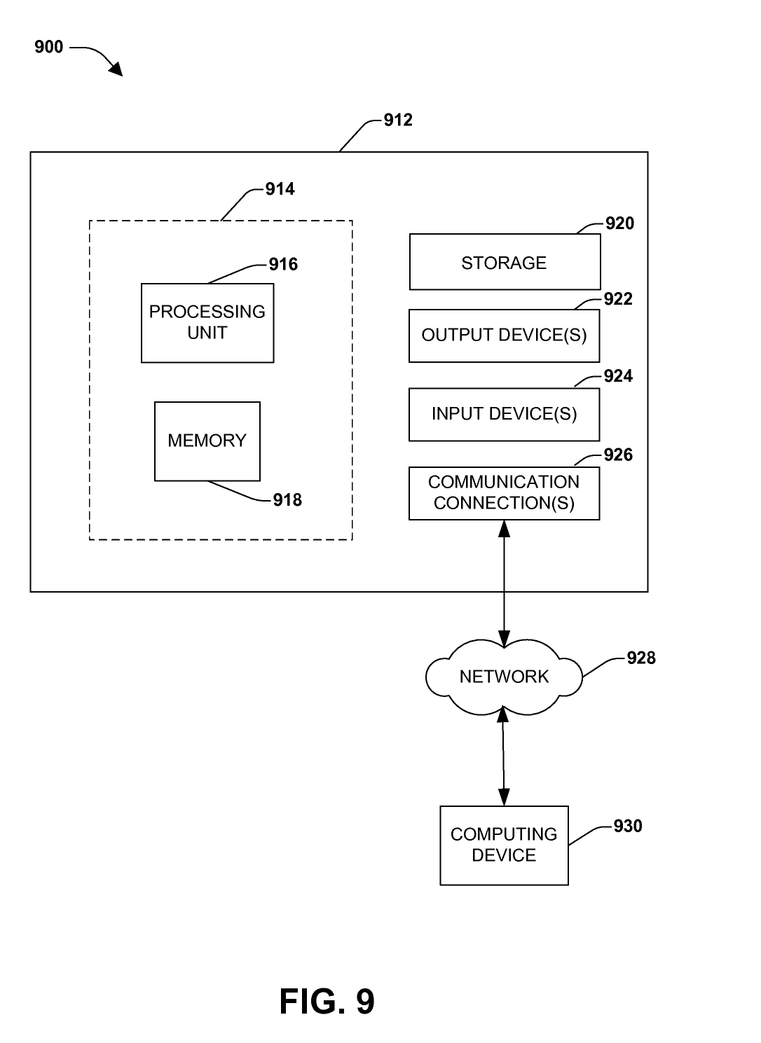

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for performing an action based upon a subscription to multi-source data, comprising:
receiving a subscription request specifying an action that is to be performed upon satisfaction of a set of conditions, the set of conditions comprising a first condition associated with a first data source and a second condition associated with a second data source;
generating a subscription based upon the subscription request;
monitoring the first data source for a first event that triggers the first condition based upon the subscription;
monitoring the second data source for a second event that triggers the second condition based upon the subscription; and
responsive to an identification of the first event as satisfying the first condition and the second event as satisfying the second condition, performing the action.

2. The method of claim 1, the set of conditions represented by an expression formatted according to a first language syntax, and the generating a subscription comprising:
converting the expression from the first language syntax to an intermediary expressive language syntax to generate a normalized expression.

3. The method of claim 2, comprising:
converting the normalized expression from the intermediary expressive language syntax to a second language syntax to generate a converted expression; and
evaluating the converted expression to identify at least one of the first condition, the first data source, the second condition, or the second data source.

4. The method of claim 1, the first data source corresponding to a first data feed, and the second data source corresponding to a second data feed different than the first data feed.

5. The method of claim 4, the first data feed comprising at least one of a calendar, client device data, a web service, a social network feed, website data, or a news feed.

6. The method of claim 1, comprising:
maintaining a graph of one or more subscriptions, the graph comprising a plurality of nodes, a node representing a condition associated with at least some of the one or more subscriptions.

7. The method of claim 6, the generating a subscription comprising:
responsive to determining that a current node within the graph represents the first condition, associating the subscription with the current node.

8. The method of claim 7, a second subscription associated with the current node, and the monitoring the first data source comprising:
responsive to the identification of the first event as satisfying the first condition:
traversing the graph to identify a second node, representing the second condition associated with the subscription, for evaluation of the second condition; and
traversing the graph to identify, a third node, associated with the second subscription, for evaluation of an additional condition of the second subscription.

9. The method of claim 6, the generating a subscription comprising:
responsive to determining the graph does not comprise at least one node representing the first condition:
generating a first node within the graph for the first condition; and
associating the subscription with the first node.

10. The method of claim 6, the maintaining a graph comprising:
maintaining a first node within the graph, the first node representing the first condition;
maintaining a second node within the graph, the second node representing the second condition; and
ordering the first node before the second node based upon the first condition being more restrictive than the second condition.

11. The method of claim 1, the subscription request comprising an expression, and the generating a subscription comprising:
decomposing the expression into the set of conditions, the first condition derived from a first subexpression decomposed from the expression, the second condition derived from a second subexpression decomposed from the expression.

12. The method of claim 6, the maintaining a graph comprising:
responsive to receiving an information event from a data source, updating one or more nodes within the graph using the information event.

13. The method of claim 1, the action corresponding to at least one of a purchase item action, a notification action to a subscription owner, a secondary notification action to a non-subscription owner, a download action, or an update social network action.

14. The method of claim 1, the performing the action comprising performing the action based upon at least one of:
the first condition being satisfied before the second condition; or
the second condition being satisfied before the first condition.

15. The method of claim 6, the generating a subscription comprising:
determining that the graph comprises a first node representing the first condition;
responsive to determining that the graph does not comprise at least one node representing the second condition, creating a second node within the graph to represent the second condition; and
constructing the subscription with a first subexpression corresponding to the first node and a second subexpression corresponding to the second node.

16. A system for performing an action based upon a subscription to multi-source data, comprising:
a subscription component configured to:
receive a subscription request specifying an action that is to be performed upon satisfaction of a set of conditions, the set of conditions comprising a first condition associated with a first data source and a second condition associated with a second data source;
generate a subscription based upon the subscription request, the subscription represented as a sequence of one or more nodes within a graph;
a notification component configured to:
monitor the first data source for a first event that triggers the first condition based upon the subscription;
monitor the second data source for a second event that triggers the second condition based upon the subscription; and
responsive to an identification of the first event as satisfying the first condition and the second event as satisfying the second condition, perform the action.

17. The system of claim 16, comprising:
a graph component configured to:
maintain the graph, a first node representing the first condition and a second node representing the second condition; and
update the first node based upon updated information from the first data source.

18. The system of claim 17, the subscription component configured to generate the subscription on a client device associated with a user for which the subscription is maintained.

19. The system of claim 16, the first data source corresponding to a first data feed, and the second data source corresponding to a second data feed different than the first data feed.

20. A computer readable medium comprising instructions which when executed at least in part via a processing unit perform a method for performing an action based upon a subscription, comprising:
receiving a subscription request specifying an action that is to be performed based upon information associated with a data source;
generating a subscription based upon the subscription request; and
responsive to the information received from the data source satisfying the subscription, performing the action.
